(19) United States
(12) Patent Application Publication
(10) Pub. No.: US 2003/0140310 A1
(43) Pub. Date: Jul. 24, 2003

(54) Automation system and method for producing a documentation

(75) Inventors: Mirko Danz, Feucht (DE); Christof Meier, Heroldsbach (DE); Joachim-Uwe Schaaf, Bruhl (DE)

Correspondence Address: HENRY M FEIEREISEN, 350 FIFTH AVENUE, SUITE 3220, NEW YORK, NY, 10118, US

(73) Assignee: SIEMENS AG, Munchen (DE)

(21) Appl. No.: 10/349,867

(22) Filed: Jan. 23, 2003

(30) Foreign Application Priority Data
Jan. 23, 2002 (DE) 102 02 498.7

(51) Int. Cl. G06F 15/00

(52) U.S. Cl. 715/500

(57) ABSTRACT

The invention is directed to an automation system with a plurality of system components, wherein each of the system components is capable of storing descriptive data. The system further includes at least one program for reading the descriptive data and for generating from the descriptive data a current document in a markup language, as well as at least one memory for storing the current document and predecessor documents. The invention is also directed to a method for generating a documentation such automation system as well as a computer program for carrying out the method.

### CROSS-REFERENCES TO RELATED APPLICATIONS

This application claims the priority of German Patent Application, Serial No. 102 02 498.7, filed Jan. 23, 2002, pursuant to 35 U.S.C. 119(a)-(d), the disclosure of which is incorporated herein by reference.

### BACKGROUND OF THE INVENTION

The present invention relates to an automation system and a method for producing a documentation in a memory of an automation system, as well as a corresponding computer program.

Before an automation system is placed in service, the system typically has to be accepted and/or validated. This applies to all types of automation systems, in particular to packaging machines, presses, plastic injection molding machines, textile machines, printing machines, machine tools, robots, handling systems, wood processing machines, glass processing machines, ceramic processing machines, hoisting devices and the like.

An automation system has to be validated in particular in the pharmaceutical industry, which applies to both the hardware and software components of such automation system. Exemplary automation systems in the pharmaceutical industry are control systems for pharmaceutical packaging machines. The validation has to be certified to the regulatory entities, for example the Food and Drug Administration (FDA) in the USA.

The activities in conjunction with validation require that technical documents of all components that are part of the entire system are assembled “by hand”, and that the overall functionality is documented by numerous individual test scenarios and their associated documentation (qualification documentation).

It mostly falls to the machine designer to qualify the components of the machine, i.e., to perform test scenarios and to provide the qualification documentation. This also includes automation components and system software which the machine designer receives typically from a supplier of the controls or controllers. Qualification measures performed on one machine cannot be reused with another machine. The validation cost can frequently exceed 10% of the cost of the entire system.

A validated machine must remain in the validated state during its operation. Changes made to the machine (e.g., installing replacement parts) must not affect on the functionality of the machine and/or the quality of the processed pharmaceutical products. At present, machine logbooks have to be maintained for documentary evidence. If there is doubt, the machine has to be revalidated which—in comparison to the value of the replacement part—is expensive and can lead to a loss in production.

It would therefore be desirable and advantageous to provide an improved automation system to obviate prior art shortcomings and to significantly reduce the time and cost associated with the validation process.

It would also be desirable and advantageous to provide an improved method for producing a documentation for an automation system and a corresponding computer program for carrying out the method.

### SUMMARY OF THE INVENTION

According to one aspect of the invention, “validation-proof” system components are used, the automation system includes system components, with each system component storing descriptive data related to the specification and/or the status of the corresponding system component. These are specific data regarding the type and/or version of the component, release dates, etc.

When initializing the automation system, the descriptive data are automatically extracted from the system components. It is then checked if the current configuration of the installation is identical to the last documented configuration. If changes are detected, then a new document is generated from the descriptive data in a markup language, for example an HTML document or an XML document.

This document is stored a memory, which can be accessed via an interface. First, access has to be authorized for an authorized user by disabling an access protection. A read access to the document can query the current configuration of the system, including its history.

If changes are detected in the system configuration, then the authorized user can update and store the current document in memory by entering comments or other additional log entries. Although no new document is generated in this case, the user's comments are stored with the current document. The successively stored documents in the status database provide a change history, i.e., a change control protocol with a log function.

During a write access, the system of the invention guarantees that a user does not overwrite, change, delete or otherwise manipulate any information that is automatically generated by the system.

According to another feature of the present invention, a validation database may be accessed before any changes are made in the current document and/or in the automation system. The validation database contains information about permitted changes, i.e., modification or updates of the automation system that can be executed without requiring a new validation, as well as information regarding the type and scope of validation measures that may be executed to make a desired change. The validation database can be queried by the user or automatically.

According to another advantageous embodiment of the invention, each hardware system component of the automation system may include a memory for storing descriptive data of the corresponding hardware component. The descriptive data are read by accessing the memory through a query program during system initialization.

According to yet another feature of the present invention, each software component of the automation system may include information with descriptive data for the corresponding software component allowing self-identification of the software component. This information is read during initialization of the system. For example, the descriptive data can be stored in a header or footer data field of the software component.

According to another advantageous embodiment of the invention, the automation system may include several controllers. Each of the controllers is connected with various hardware and software components. A partial document is generated in each of the controllers which includes the descriptive data of the system components connected with the corresponding controller. This partial document is read during initialization of the automation system and merged with the other descriptive data to form a complete current document which is then stored.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic block diagram of an exemplary embodiment of an automation system according to the invention;

FIG. 2 shows a flow diagram of an exemplary embodiment of the method according to the invention; and

FIG. 3 shows a flow diagram for querying the validation database in the event that a spare part is exchanged.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way.

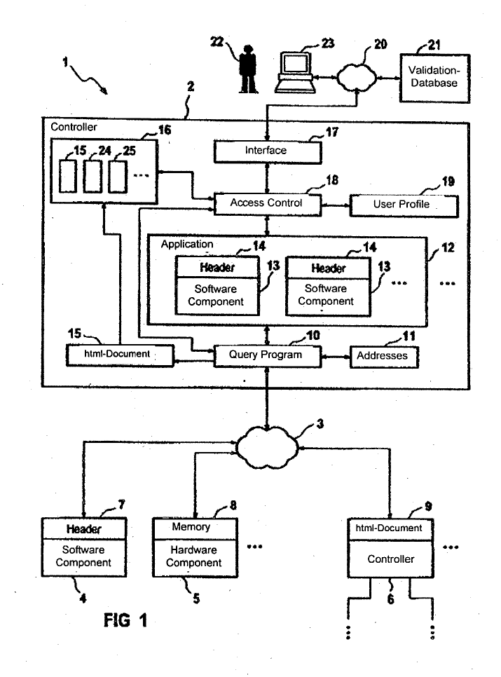

Turning now to the drawing and in particular to FIG. 1, there is shown an exemplary automation system 1 with a controller 2. The controller 2 can be implemented as a stored program control (SPC), for example a controller of the type SIMOTION distributed by the company Siemens AG, Munich, Germany. The controller 2 is connected, for example, via a network 3 with various system components, such as software components 4, hardware components 5 and one or more additional controllers 6.

The network 3 can be implemented as a Fieldbus, Profibus, Ethernet, Industrial Ethernet, FireWire or another type of communication system known in the art.

Each software component 4 includes a header data field 7 with descriptive data associated with the software component 4. The descriptive data can relate to a certain application, a version number and/or other specification data.

Each hardware component 5 further includes a memory 8 for storing the descriptive data. The descriptive data for the hardware component 5 in the memory 8 relate, for example, to technical data of the hardware component, in particular the type and the version number of the hardware component. The controller 6, on the other hand, can generate a partial document 9 which includes the descriptive data of other hardware components (not shown) and software components (not shown) connected to the controller 6.

The controller 2 includes a query program 10 which can access via the network 3 the software components 4, the hardware components 5 as well as the controllers 6 in order to read to the descriptive data from the header data field 7 and/or the memories 8 and the partial documents 9 of controllers 6. The query program 10 accesses an address memory 11 which includes the addresses of the header data field 7 and of the memories 8 as well as the addresses for querying the partial document 9. The controller 2 includes at least one application 12. The application 12 can be a distributed application, i.e., one or more software components 13 of the application 12 running on the controller 2, whereas the other software components 4 and/or hardware components 5 of the application are accessed via the network 3. Each of the software components 13 has a header data field 14 which includes the descriptive data of the corresponding software component 13, much like the header data fields 7 of the software components 4.

The addresses of the header data field 14 are also stored in the address memory 11. The query program 10 uses the addresses in the address memory 11 to address the header data fields 14 and reads the descriptive data of the software components 13 which are located in the controller 2 itself. Additional software components 4 and/or hardware components 5 can also be included in the controller 2.

From the descriptive data of the software and hardware components and of the controllers in the automation system associated with different applications, the query program 10 generates a document 15 in a markup language, for example HTML or XML. This document 15 is stored in a memory 16. The current document 15 and the predecessor documents 24, 25 stored in memory 16 can be accessed via an interface 17. A distinction is made between a read access and a write/(read) access.

Only certain authorized users are permitted to execute a write/(read) access. Access rights are administered and access is controlled by an access control program component 18 linked to a memory 19 that stores user profiles with the corresponding access rights.

A validation database 21 can be accessed via a network 20, for example the Internet. The validation database 21 includes a mirror of the validated automation system 1 and advantageously also additional information about the installed components and about their lifecycle. Advantageously, the network 20 can also be used for data access, for example to perform remote maintenance, also referred to as teleservice.

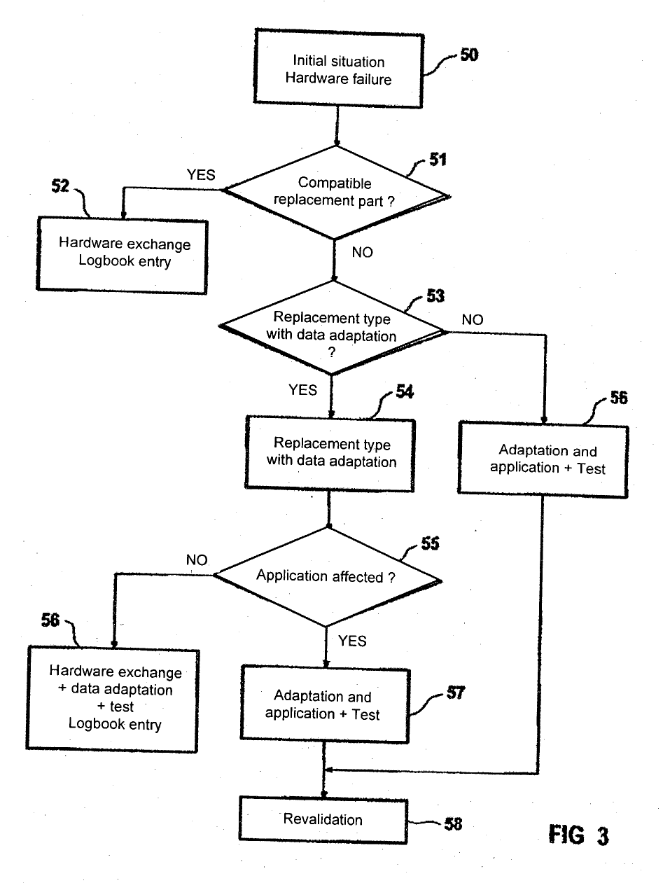

The validation database 21 includes, for example, for each system component of the automation system 1 information about the functionality and compatibility of the component, as well as other descriptive data. Suitably, the validation database 21 is created when the automation system 1 is designed and implemented. This can be done with software, for example, with project management software. The validation database 21 is maintained for each system component over the lifecycle of the component and can provides information about important system parameters, e.g., the system compatibility and/or replacement components that can be exchanged for which the current system component without requiring a new validation. The validation database 21 can also include information about measures to be taken for revalidating the system component. This will be discussed in more detail below with reference to FIG. 3. The validation database can be accessed automatically by the controller 2 or by a user 22 via a client computer 23.

When a hardware component 5 is exchanged, the user 22 can start the query program 10 via the interface 17. The query program 10 queries the current descriptive data of the system components and compares the so determined descriptive data with the descriptive data in the current document 15. An exchange of a hardware component 5 can result in a discrepancy between the descriptive data of the current document 15 and the descriptive data determined by the query. Based on this discrepancy, the query program 10 uses the newly determined descriptive data to generate a new current document and stores this new document in the memory 16.

The query program 10 can be started into different ways:

Each time the automation system 1 is switched on. Before a production run starts, the query program 10 is started automatically, for example, after initialization of the automation system 1 so as to query the descriptive data of the individual system components. The query program 10 compares the descriptive data with the descriptive data stored in the current document 15 in memory 16. If the currently determined descriptive data of the system components agree with the descriptive data of the document 15 in memory 16, then the query program 10 does not create a new document. The query program 10 then enables the start of the production run without additional steps. Conversely, if a discrepancy is detected between the newly determined descriptive data and the descriptive data of the document 15 in memory 16,, then the query program 10 automatically creates a new current document 15 with the currently determined descriptive data and stores this document in memory 16. Advantageously, the query program 10 also transmits a message via the interface 17 which can be displayed on the monitor of the client computer 23. The user 22 can then check if the discrepancy in the newly determined descriptive data determined by the query program 10 is acceptable or not. Only after the user 22 confirms the acceptability of the descriptive data through a corresponding input via the client computer 23, start of the production is enabled by the query program 10.

At the end of maintenance work. For performing maintenance work, the user 22 will initially shut down the automation system 1. The state of the automation system before shutdown is documented in the current document 15 of memory 16. At the end of the maintenance work, the user 22 can call the query program 10 via the interface 17. The query program 10 determines the current descriptive data of system components and compares them with the descriptive data of the document 15 in memory 16. If a discrepancy is detected, a new document 15 is again created and stored in memory 16. As before, the query program 10 advantageously transmits a corresponding message to the client computer 23. Only after the user 22 has confirmed the change is the automation system 1 reactivated.

The memory 16 therefore stores the corresponding current document 15 and the predecessor documents of the current document 15, i.e., the documents 24, 25, . . . The individual documents 15 and 24, 25, . . . reflect the change history of the automation system 1 as well as the current state of the system. When visually displayed, the documents 15 and 24, 25, . . . represent the individual pages of a logbook and hence form an automated change control protocol.

A properly authorized user 22 can perform any write/read access to the current document 15 and/or the predecessor documents 24, 25, . . . for the purpose of, for example, inserting comments about the reasons for performing the maintenance work. System information can and/or need no longer be entered and/or changed by hand, since the query program 10 automatically compiles the information by querying the descriptive data of the system components and optionally stores the information in the current document 15.

The automation system 1 can be implemented as a distributed automation system, i.e., by providing one or more additional controllers 6 in addition to the controller 2. The at least one additional controller 6 can be identical or similar to the controller 2, but may have a reduced functionality and/or can be an intelligent drive.

Each of the additional controllers 6 includes a program that corresponds to the query program 10 of the controller 2. Each of the controllers 6 can use these programs to create a partial document 9; the information included in the individual partial document 9 has the form of descriptive data which is queried by the query program 10 of the controller 2 and merged with the descriptive data of the additional system components to create a complete document.

For example, a failure of one of the hardware components 5 can disrupt the operation of the automation system 1. The user 22 can then read the contents of memory 16 or the current document by a read access via interface 17. If the user 22 is an authorized user as reflected in the user profile 19, then access protection is disabled by the access protection program component 18, so that the user 22 can make changes in the current document, for example by entering comments. To exchange a malfunctioning hardware component 5, the user 22 first accesses the validation database 21 via the client computer 23 and the network 20 to find a compatible replacement part. The user 22 can then exchange the malfunctioning hardware component 5 with the compatible replacement part.

The documents 15, 24, 25, . . . stored in memory 16 hence reflect the change history of the automation system 1. Preferably, each change is also linked to the identity of the user making the change. This permits verification to, for example, regulatory agencies in form of a logbook and/or a change control protocol that the automation system 1 has operated continuously in a validated state.

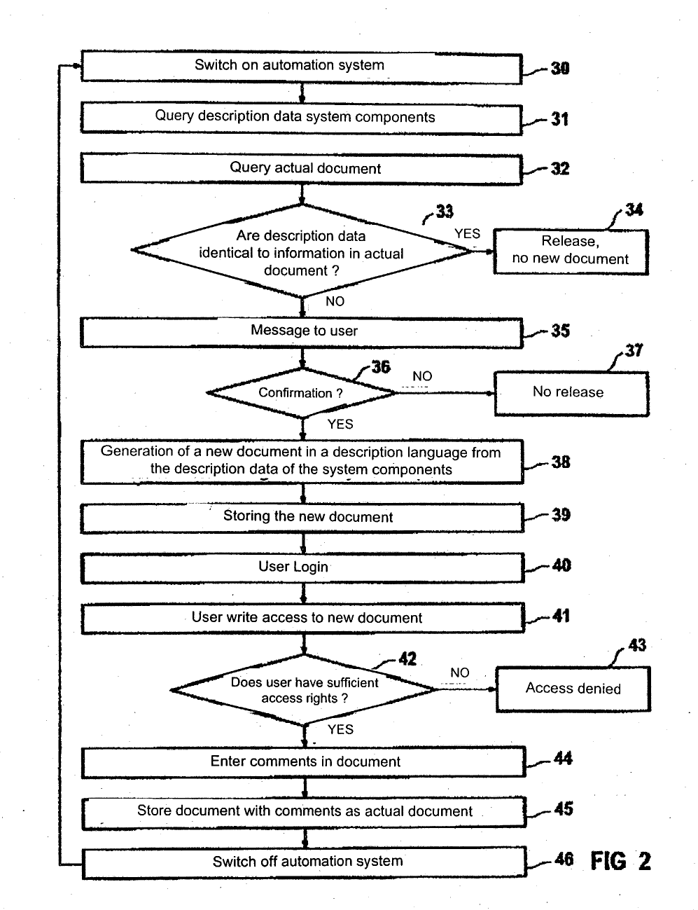

FIG. 2 shows a flow diagram of an exemplary embodiment of the automation system according to the invention. In step 30, the automation system is switched on. In step 31, the descriptive data of the system components are queried. This is done by starting the query program 10 (see FIG. 1) which queries header data fields 7 and 14 of software components 4 and 13, respectively, as well as memories 8 of hardware components 5 and partial documents 9 residing in controllers 6. In step 32, the current document (see document 15 of memory 16) is queried. In step 33, the descriptive data stored in the current document are compared with the descriptive data queried in step 31. If no discrepancy is detected between the descriptive data determined in step 31 and the descriptive data of the current document, then the automation system is in a validated state.

As a result, the activation of the automation system is enabled in step 34. A new “logbook entry” need not be created since the configuration of the automation system has not changed. It is also not necessary to create and store a new document.

If a discrepancy is detected in step 33, then a corresponding message can be generated in step 35 which can be transmitted to the user. The user can then check the discrepancy to determine if the automation system is in a validated state in spite of the discrepancy. This check can be performed, for example, using the validation database 21.

If the check in step 36 shows that the automation system is not in a validated state, then the system is not enabled in step 37. In this situation, a validation has to be performed first.

Conversely, if it is confirmed in step 36 that the automation system is in a validated state, then step 38 is performed. Steps 35 and 36 can be performed either fully automatically or only partially automatically by sending the message in step 35 directly to an automatic validation system which checks if the discrepancy is acceptable or not.

In step 38, a new document with the descriptive data of the system components determined in step 31 is generated and stored. This also creates a new logbook entry documenting the changed current configuration of the automation system. This new document is stored in step 39.

In step 40, a user logs on, for example to enter a comment in the current document stored in step 39. This comment can relate, for example, to a change made by a user in the automation system. For this purpose, the user initiates a write access to the current document in step 41. In step 42, it is checked if the user has adequate access rights for such write access. If this is not the case, then the user is denied write access in step 43.

Conversely, if the user has adequate access rights, then he can make the desired change in the current document in step 44, for example by entering a comment. In step 45, the document with the comment is stored as the new current document.

In step 46, the automation system is powered down, for example for performing maintenance or repair work or at the end of the shift. When the automation system is later switched on again, all or at least a portion of the steps 30 to 45 described above are executed again.

Over time, documents describing the corresponding configuration of the automation system are successively stored, thereby documenting the change history of the automation system. This documentation can function as proof that the automation system was at any time in a validated state.

FIG. 3 shows a flow diagram for a situation where one of the hardware components 5 (see FIG. 1) has failed. A malfunction or failure of hardware is determined in step 50. If an identical hardware component with identical descriptive data is available, then the malfunctioning hardware component 5 can simply be exchanged. If an identical hardware component is not available, then it is checked in step 51 if the malfunctioning hardware component 5 can be exchanged for a compatible replacement part. The check is performed with a corresponding query to the validation database 21 (FIG. 1). If the malfunctioning hardware component is exchanged for a compatible replacement part, then a corresponding command is entered in the current document in memory, step 52. This corresponds to a “logbook entry.”

If a malfunctioning hardware component cannot be exchanged for a compatible replacement part or if a suitable compatible replacement part is not available, then it is checked in step 52 if another type of replacement part could be used by adapting certain control data. If this is feasible, then the defect hardware component is exchanged for that other type of replacement part in step 54, with the control data being adapted.

It is then checked in step 55 if the application is affected by the exchange of the defect hardware component by that type of replacement part and by adapting the data. If this is not the case, then the exchange of the hardware component including adaptation of the data and the tests are stored in the current document and a corresponding logbook entry is generated, step 56.

If the check in step 53 determines that the exchange with a replacement type part is not possible even with data adaptation or if the check in step 55 determines that the application is affected by such an exchange, then steps 56 and/or 57 are performed to adapt and test the application. Only in these two situations is a revalidation of the automation system in step 58 required.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. Automation system comprising:
a plurality of system components, wherein each of the system components is capable of storing descriptive data;
a first program for reading the descriptive data and for generating from the descriptive data a current document in a markup language; and
a first memory for storing the current document and predecessor documents.

2. The automation system of claim 1, wherein the system components include components selected from the group consisting of hardware, software and control units.

3. The automation system of claim 2, wherein at least one of the hardware components includes a second memory for storing the descriptive data of the at least one hardware component.

4. The automation system of claim 2, wherein at least one of the software components includes a data field for storing the descriptive data of the at least one software component.

5. The automation system of claim 2, wherein at least one of the control units includes a second program for creating a current partial document of partial system components associated with the at least one control unit, said current partial document being created in a markup language and comprising the descriptive data of the at least one control unit.

6. The automation system of claim 1, and further comprising an interface enabling a write/read access to the current document in the first memory, and an access protection for controlling write access to the current document and to predecessor documents.

7. The automation system of claim 1, and further comprising an interface connected to a validation database, with the validation database providing a validation check to permit a change in the descriptive data.

8. In a method for generating a documentation for an automation system, wherein the automation system includes a plurality of system components capable of storing descriptive data, said method comprising the steps of:
reading the descriptive data of system components;
generating from the descriptive data a current document in a markup language; and
storing the current document in a memory.

9. The method of claim 8, and further comprising the steps of identifying a user; accessing a user profile of the user and determining access authorization for the user; if the user is authorized, disabling an access protection for a write access to the first memory; entering a comment into the current document; and automatically storing identifying information of the user who entered the comment.

10. The method of claim 8, and further comprising the steps of requesting a change in the current document; accessing a validation database to check if a validation is required for the requested change; and changing the current document if either no validation is required or the requested change is authorized by the validation database.

11. The method of claim 9, wherein the comment includes a change in the current document, and further comprising the steps of accessing a validation database to check if a validation is required for the change; and changing the current document if either no validation is required or the change is authorized by the validation database.

12. A computer program for executing on a computer in an automation system having a plurality of system components capable of storing descriptive data, the computer program comprising:
computer program code for reading the descriptive data of system components;
computer program code for generating from the descriptive data a current document in a markup language, and
computer program code for storing the current document in a memory.

13. The computer program of claim 12, and further comprising computer program code for identifying a user; computer program code for accessing a user profile of the user and determining access authorization for the user; computer program code for disabling an access protection for a write access to the first memory, if the user is authorized; computer program code for entering a comment into the current document; and computer program code for automatically storing identifying information of the user who entered the comment.

14. The computer program of claim 12, and further comprising computer program code for requesting a change in the current document; computer program code for accessing a validation database to check if a validation is required for the requested change; and computer program code for changing the current document if either no validation is required or the requested change is authorized by the validation database.
